(19) United States
(12) Patent Application Publication
(10) Pub. No.: US 2006/0267478 A1
(43) Pub. Date: Nov. 30, 2006

(54) Field emission device (FED)

(76) Inventor: Tae-Sik Oh, Suwon-si (KR)

Correspondence Address: Robert E. Bushnell, Suite 300, 1522 K Street, N.W., Washington, DC, 20005, US

(21) Appl. No.: 11/431,082

(22) Filed: May 10, 2006

(30) Foreign Application Priority Data
May 24, 2005 (KR) 10-2005-0043747

(51) Int. Cl. H01J 1/62; H01J 63/04

(52) U.S. Cl. 313/495; 313/496

(57) ABSTRACT

A Field Emission Device (FED) with a quadruple lens structure includes: a rear substrate on which a cathode electrode is formed; emitters formed on the cathode electrode and adapted to emit electron beams; a gate electrode placed above an upper surface of the cathode electrode and adapted to extract electrons from the emitters; a front substrate facing an upper surface of the rear substrate where an anode electrode and a fluorescent layer are formed on a lower surface of the front substrate; and a quadruple lens structure corresponding to each of the emitters and formed between the cathode electrode and the anode electrode.

### CLAIM OF PRIORITY

This application makes reference to, incorporates the same herein, and claims all benefits accruing under 35 U.S.C.§119 from an application for FIELD EMISSION DE VICE earlier filed in the Korean Intellectual Property Office on the 24^{th} of May 2005 and there duly assigned Serial No. 10-2005-0043747.

### BACKGROUND OF THE INVENTION

1. Field of the Invention

The present invention relates to a Field Emission Device (FED), and more particularly, to an FED in which an electrostatic quadruple lens structure is arranged between an emitter on a cathode and an anode to improve focusing.

2. Description of the Related Art

Generally, a Field Emission Device (FED) can be applied to a planar display or a light emitting device which emits electrons by applying an electric field to an emitter arranged on a cathode electrode from a gate electrode. These electrons collide with a fluorescent material coated on an anode electrode, and light is emitted. Also, a so-called FED with a double gate structure further includes a focus electrode in addition to a gate electrode.

The brightness and color purity of the FED, in which light is emitted using electron beams emitted from a cold cathode depends not only on the material and structure of the emitter which is the source of electrons but also on the focusing effect to focus an emitted electron beam accurately onto a fluorescent material pattern to emit light. That is, to realize a high resolution display device using an FED, techniques of focusing the electron beam on the target fluorescent material pattern and preventing the electron beam from being located on other adjacent fluorescent materials are required.

Moreover, when a high voltage is supplied to the anode to obtain high brightness and durability, the distance between the emitter and the anode must be increased for electrical stability. However, as the distance between the emitter and the anode is increased, the electron beams are more likely to disperse. Thus, a structure which can transmit the electron beams to the fluorescent material pattern and focus more accurately thereon is required.

An FED with a double gate structure includes an emitter disposed above a cathode electrode and emitting electrons; a gate electrode thereon which extracts electrons and has a circular first opening portion surrounding the emitter; and a focus electrode disposed thereon which focuses the extracted electron beams and has a circular second opening portion having a common circle center with the first opening portion. Also, the gate electrode is insulated from the cathode electrode and the focus electrode is insulated from the gate electrode.

When an electron beam emitted from the FED cannot emit light to a pixel area sufficiently, a plurality of FEDs can be arranged corresponding to a pixel area.

When a focus electrode voltage Vf is 0 V, electron beams having a circular shape are focused across a wide area, and as the voltage increases, the beams are more narrowly focused. However, when the focus electrode voltage is about 50 V, a halo appears around the electron beam, thus increasing the arrival area.

Generally, in a display device using an FED, the fluorescent material pattern is in the form of vertical stripes. On the other hand, since an electron beam reaching the anode has a circular shape according to the double gate structure, the electron beam is likely to deviate from the length of the fluorescent material.

Also, the optimal focusing effect is achieved at a focus electrode voltage Vf of −40 V. That is, to obtain a sufficient focusing effect in a double gate structure, the potential between a focus electrode and a gate electrode may be great, and thus an electrical breakdown can occur between the focus electrode and the gate electrode.

### SUMMARY OF THE INVENTION

The present invention provides a Field Emission Device (FED) which focuses an electron beam emitted from the emitter and transforms a cross-section of the electron beam into a stripe shape corresponding to the fluorescent pattern.

The present invention also provides a Field Emission Device (FED) which includes a focus electrode having a lower electrical potential with respect to a gate electrode.

According to one aspect of the present invention, a Field Emission Device (FED) is provided including: a rear substrate including a cathode electrode arranged thereon; emitters arranged on the cathode electrode and adapted to emit a plurality of electron beams; a gate electrode arranged above an upper surface of the cathode electrode and adapted to extract electrons from the emitters; a front substrate facing the rear substrate, the front substrate including an anode electrode and a fluorescent layer arranged on a lower surface thereof; and a quadruple lens structure arranged between the cathode electrode and the anode electrode and corresponding to each emitter.

The quadruple lens structure is preferably adapted to transform a cross-section of the electron beams emitted from the emitters to reduce a horizontal width of the cross-section.

A vertical length of the electron beams is preferably equal to a sub-pixel pitch of a fluorescent pattern.

The FED preferably further includes a focus electrode arranged above the upper surface of the gate electrode, the quadruple lens structure including the gate electrode and the focus electrode.

According to another aspect of the present invention, a Field Emission Device (FED) is provided including: a rear substrate including a cathode electrode arranged on an upper surface thereof; emitters arranged on the cathode electrode and adapted to emit electrons; a gate electrode arranged above an upper surface of the cathode electrode and including a first insulating layer arranged therebetween and horizontal first opening portions adapted to extract electrons from the emitters; a focus electrode arranged above an upper surface of the gate electrode and including a second insulating layer arranged therebetween and a vertical second opening portion, at least a part of the second opening portion being in line with the first opening portions; a front substrate facing an upper surface of the rear substrate and including an anode electrode arranged on a lower surface of the front substrate; and a vertical fluorescent pattern arranged on a lower surface of the anode electrode.

A voltage of the gate electrode is preferably greater than a voltage of the focus electrode. The voltage of the focus electrode is preferably equal to a ground potential. The voltage of the focus electrode is alternatively preferably in a range of 0 V to −30 V.

The first opening portion preferably has one of a horizontally rectangular shape and a horizontally oval shape, and the second opening portion has one of a vertically rectangular shape and a vertically oval shape. The first opening portion alternatively preferably has one of a horizontally rectangular shape and a horizontally oval shape, and the second opening portion has a square or circular shape.

A horizontal axis of the second opening portion is preferably eccentric with respect to a horizontal axis of the emitter and is adapted to deflect the electron beam in an eccentric direction.

According to still another aspect of the present invention, a Field Emission Device (FED) is provided including: a rear substrate including a cathode electrode arranged thereon; a group of emitters arranged on the cathode electrode and adapted to emit electrons; a gate electrode arranged above an upper surface of the cathode electrode and adapted to extract electrons from the emitters; a front substrate facing an upper surface of the rear substrate and including an anode electrode arranged on a lower surface of the front substrate; a fluorescent pattern arranged on a pixel area of the lower surface of the anode electrode and adapted to emit light by a collision of beams of electrons with the anode electrode; and a quadruple lens structure arranged between the cathode electrode and the anode electrode and corresponding to each emitter.

The group of emitters preferably includes a plurality of emitters arranged in a vertical column and the quadruple lens structure is preferably adapted to reduce a horizontal width of the emitted electron beams from each emitter.

The FED preferably further includes a focus electrode arranged above an upper surface of the gate electrode, the quadruple lens structure including the gate electrode and the focus electrode. The quadruple lens structure is preferably adapted to deflect electron beams to a center of the group of emitters. The quadruple lens structure is preferably adapted to deflect electron beams of the emitters disposed relatively far from the center of the group of emitters more than electron beams of the emitters disposed relatively near to the center of the group of emitters.

According to yet another aspect of the present invention, a Field Emission Device (FED) is provided including: a rear substrate including a cathode electrode arranged on an upper surface thereof; a group of emitters arranged on the cathode electrode and adapted to emit electrons; a gate electrode arranged above the upper surface of the cathode electrode and including a first insulating layer arranged therebetween and horizontal first opening portions corresponding to each emitter and adapted to extract electrons from the emitter; a focus electrode arranged above the upper surface of the cathode electrode and including a second insulating layer arranged therebetween and a vertical second opening portion; at least a part of the second opening portion being in line with the first opening portions; a front substrate facing the upper surface of the rear substrate and including an anode electrode arranged on a lower surface of the substrate; and a fluorescent pattern adapted to emit light due to collision of electron beams therewith.

A voltage of the gate electrode is preferably greater than a voltage of the focus electrode. The voltage of the focus electrode is preferably equal to a ground potential. The voltage of the focus electrode is alternatively preferably in a range of 0 V to −30 V.

The first opening portion preferably has one of a horizontally rectangular shape and a horizontally oval shape, and the second opening portion has one of a vertically rectangular shape and a vertically oval shape. The first opening portion alternatively preferably has one of a horizontally rectangular shape and a horizontally oval shape, and the second opening portion has one of a square shape or a circular shape.

The group of emitters preferably include a plurality of emitters arranged in a vertical column.

The second opening portion corresponding to a part of the group of emitters preferably has a horizontal axis eccentric with respect to a horizontal axis of the group emitters and is preferably adapted to deflect electron beams in an eccentric direction. The second opening portion corresponding to emitters arranged outside the group of emitters preferably has a horizontal axis eccentric with respect to a horizontal axis of the group of emitters and is preferably adapted to deflect electron beams in an eccentric direction.

As the distance of the emitters increases from a center of the group of the emitters, a horizontal axis of the second opening portion corresponding to each emitter preferably becomes more eccentric with respect to the horizontal axis of the emitters.

As described above, ‘vertical’ refers to a shape whose vertical length is longer than its horizontal length, and ‘horizontal’ refers to a shape whose horizontal length is longer than its vertical length. The terms ‘vertical’ and ‘horizontal’ do not denote absolute directions but refer to a relative perpendicular direction. Also, a pixel area indicates a uniform fluorescent pattern in a display device, and a one-color light emitting area, that is, a sub-pixel in a color display device, respectively.

### BRIEF DESCRIPTION OF THE DRAWINGS

A more complete appreciation of the present invention and many of the attendant advantages thereof will be readily apparent as the present invention becomes better understood by reference to the following detailed description when considered in conjunction with the accompanying drawings in which like reference symbols indicate the same or similar components, wherein:

FIG. 1A is a SEM image of a Field Emission Device (FED) with a double gate structure;

FIG. 1B is a planar view of the FED of FIG. 1A;

FIG. 2A is a planar view of an FED with a double gate structure arranged to correspond to pixel areas;

FIG. 2B includes simulation images of electron beam spots on the surface of an anode of the FED of FIG. 2A;

FIG. 3 is a conceptual scheme of the concept of an electrostatic quadruple lens according to an embodiment of the present invention;

FIG. 4 is a perspective view of a quadruple lens structure of an FED according to an embodiment of the present invention;

FIGS. 5A and 5B are simulation images of the trajectory of an electron beam of an FED according to the present invention;

FIG. 6 is a planar view of an FED according to an embodiment of the present invention;

FIG. 7 includes simulation images of electron beam spots on a surface of an anode of the FED of FIG. 6 according to an embodiment of the present invention;

FIGS. 8A and 8B are planar views of an FED according to further embodiments of the present invention;

FIG. 9 is a planar view of an FED according to another embodiment of the present invention;

FIG. 10 is a simulation image of the trajectory of an electron beam of the FED illustrated in FIG. 9 according to an embodiment of the present invention;

FIGS. 11A and 11B are planar views of an FED according to further embodiments of the present invention;

FIG. 12 is a simulation image of electron beam spots on a surface of an anode of the FED in FIG. 9 according to an embodiment of the present invention;

FIG. 13 is a planar view of an FED according to another embodiment of the present invention;

FIG. 14 includes simulation images of electron beam spots on a surface of an anode of the FED in FIG. 9 according to an embodiment of the present invention;

FIG. 15 is a planar view of an FED according to another embodiment of the present invention;

FIG. 16 includes simulation images of electron beam spots on a surface of an anode of the FED of FIG. 15 according to an embodiment of the present invention.

### DETAILED DESCRIPTION OF THE INVENTION

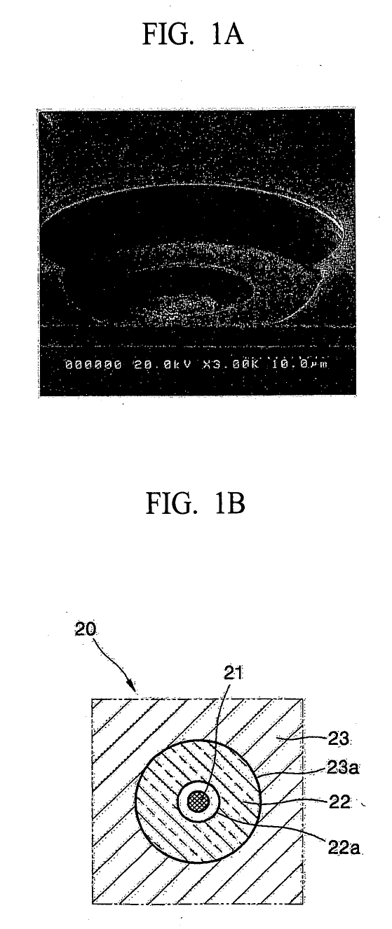

FIG. 1A is a SEM photograph of an Field Emission Device (FED) with a double gate structure, and FIG. 1B is a plane view of the FED of FIG. 1. An FED 20 with a double gate structure includes an emitter 21 disposed above a cathode electrode and emitting electrons; a gate electrode 22 thereon which extracts electrons and has a circular first opening portion 22a surrounding the emitter 21; and a focus electrode 23 disposed thereon which focuses the extracted electron beams and has a circular second opening portion 23a having a common circle center with the first opening portion 22a. Also, the gate electrode 22 is insulated from the cathode electrode and the focus electrode 23 is insulated from the gate electrode 22.

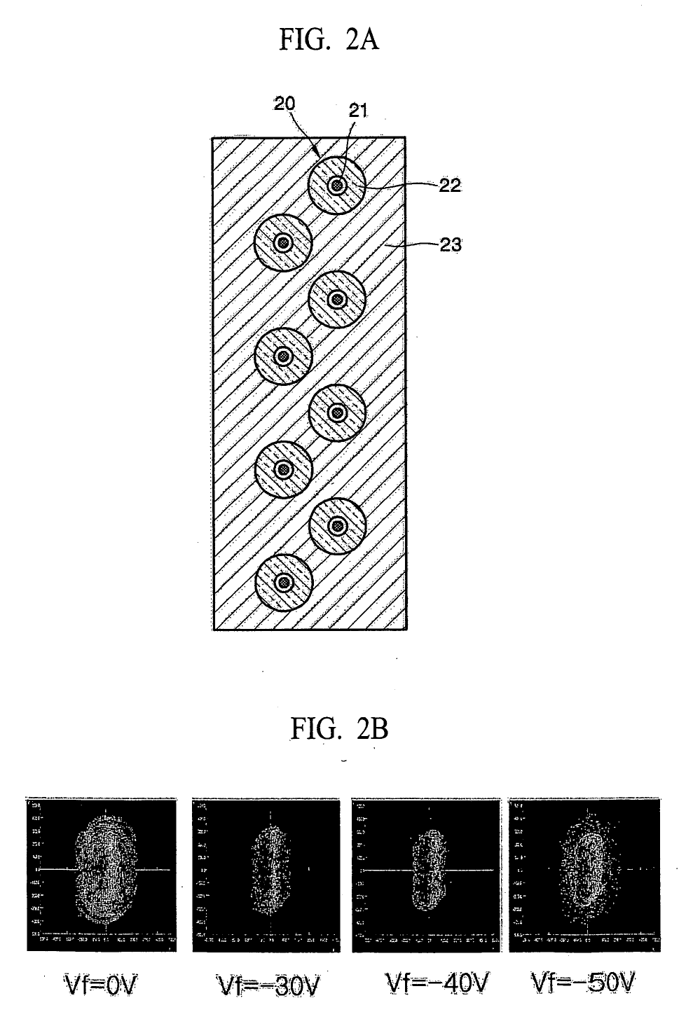

FIG. 2A is a planar view of FEDs with a double gate structure corresponding to each pixel area. When an electron beam emitted from the FED 20 cannot emit light to a pixel area sufficiently, a plurality of FEDs 20 can be arranged corresponding to a pixel area as illustrated in FIG. 2A.

FIG. 2B includes simulation images of electron beam spots on an anode surface of the FED of FIG. 2A. The images illustrate the shape of the electron beams reaching the anode according to the voltage supplied to the focus electrode. When a focus electrode voltage Vf is 0 V, electron beams having a circular shape are focused across a wide area, and as the voltage increases, the beams are more narrowly focused. However, when the focus electrode voltage is about 50 V, a halo appears around the electron beam, thus increasing the arrival area.

Generally, in a display device using an FED, the fluorescent material pattern is in the form of vertical stripes. On the other hand, since an electron beam reaching the anode has a circular shape according to the double gate structure, the electron beam is likely to deviate from the length of the fluorescent material.

Also, referring to FIG. 2B, the optimal focusing effect is achieved at a focus electrode voltage Vf of −40 V. That is, to obtain a sufficient focusing effect in a double gate structure, the potential between a focus electrode and a gate electrode may be great, and thus an electrical breakdown can occur between the focus electrode and the gate electrode.

The present invention is described more fully below with reference to the accompanying drawings, in which exemplary embodiments of the present invention are shown.

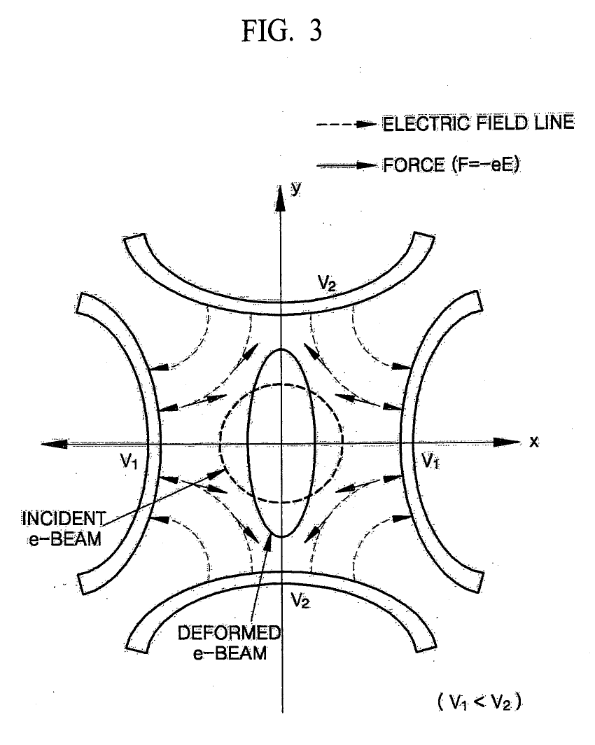

FIG. 3 is a conceptual scheme of the concept of an electrostatic quadruple lens according to an embodiment of the present invention. FIG. 3 illustrates electron beams from a perpendicular direction and two electrodes of the quadruple device facing each other and having the same potential. For example, two electrodes facing each other and disposed vertically have the same potential V₁, and two electrodes facing each other and disposed horizontally have the same potential V₂. If V₁ is greater than V₂, an electric field is formed and electric field lines are illustrated from V₁ to V₂, and negatively charged electrons receive an electric force (F=eE) tangental to electric field lines in an opposite direction to the electric field lines. Accordingly, electron beams of a circular cross-section which progress into the center of the coordinates of FIG. 3, pass through the quadruple lens and the circular cross-section is reduced in size.

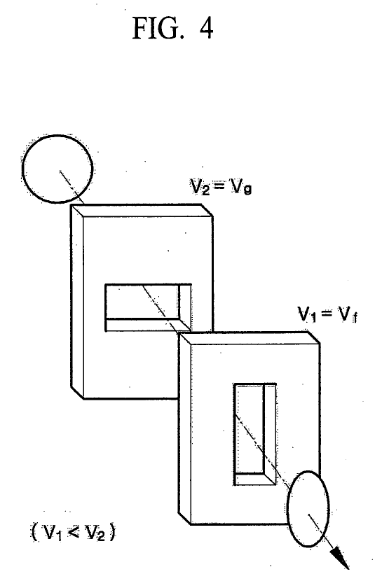

FIG. 4 is a perspective view of a quadruple lens structure of an FED according to an embodiment of the present invention. Conventionally, a fluorescent pattern of a display device using an FED is shaped to have a greater vertical length than a horizontal width. Accordingly, the quadruple lens structure in the FED of FIG. 3, can reduce the horizontal width and increase the vertical length of a cross-section of an electron beam.

In the FED of FIG. 4, a positive voltage Vg is supplied to a gate electrode, which is installed close to an emitter and a lower voltage is supplied to a focus electrode. Thus a quadruple lens structure can be provided in which V₁ is equal to Vf, and V₂ is equal to Vg (V₁<V₂) by the gate electrode and the focus electrode. That is, the quadruple lens structure according to the present embodiment can have a horizontal opening portion so that the gate electrode can be a pair of electrodes horizontally facing each other, and the focus electrode can be a pair of electrodes vertically facing each other.

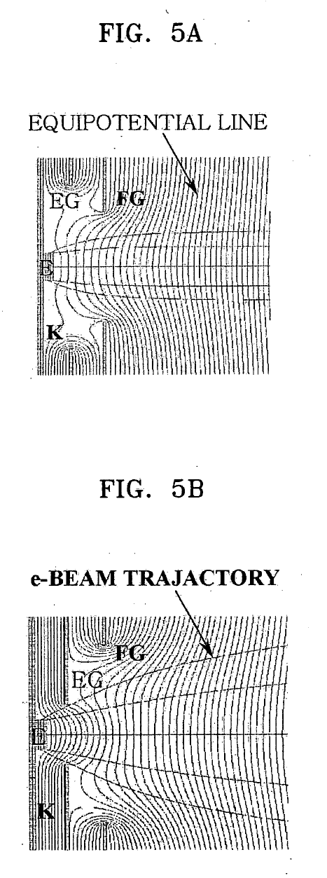

FIGS. 5A and 5B are simulation images of the trajectory of an electron beam of an FED according to an embodiment of the present invention. FIG. 5A illustrates a horizontal cross section of an FED and FIG. 5B illustrates a vertical cross-section of an FED. As described above, the horizontal width of electron beams emitted from the emitters is reduced by a quadruple lens structure composed of a gate electrode EG and a focus electrode FG.

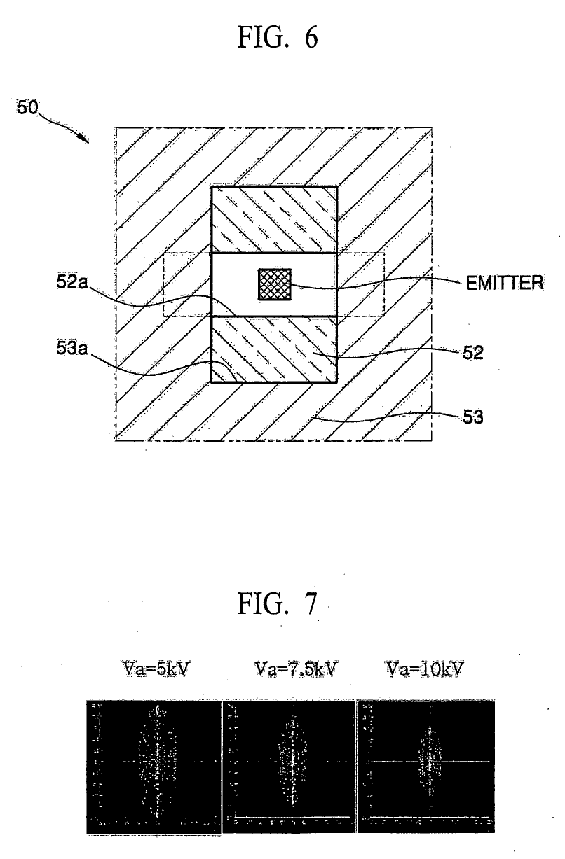

FIG. 6 is a planar view of an FED 50 according to an embodiment of the present invention. The FED 50 according to the current embodiment includes an emitter formed on an upper surface of a cathode electrode, a gate electrode 52 arranged on the upper side of the cathode electrode and having a horizontal first opening portion 52a, and a focus electrode 53 arranged on the upper side of the gate electrode 52 and having a second opening portion 53a, at least a part of which is in line with the first opening portion 52a. A first insulating layer (not shown) is disposed between the cathode electrode and the gate electrode 52, and a second insulating layer (not shown) is disposed between the gate electrode 52 and the focus electrode 53. This stack structure is formed on an upper surface of a rear substrate of the FED. An anode electrode and a fluorescent pattern are formed on a lower surface of a front substrate (not shown), which is disposed opposite to the upper surface of the rear substrate. The fluorescent pattern can be horizontal. The horizontal first opening portion 52a of the gate electrode 52 and the second opening portion 53a of the focus electrode 53 are aligned with each other and thus provide a channel through which electron beams emitted from the emitters pass. The first and second opening portions 52a and 53a are respectively at potentials Vg and Vf, and form a predetermined electric field in the channel. Thus, a quadruple lens structure transforms a cross-section of the electron beams.

FIG. 7 includes simulation images of electron beam spots on the surface of an anode of the FED of FIG. 6 according to an embodiment of the present invention. The distance from the emitter to the anode is 1.5 mm, and the voltage of the cathode electrode Vc is in the range of −43 V to −29 V. The voltage of the gate electrode Vg is 40 V; the voltage of the focus electrode Vf is 0 V; and the voltage of the anode Va is in the range 5 kV to 10 kV. The horizontal width of the electron beams on the surface of the anode is reduced. Furthermore, the voltage of the focus electrode Vf is 0 V, much less than the voltage of the gate electrode Vg in comparison with a conventional double structure. The voltage of the focus electrode Vf is preferably in the range of 0 V to −30 V. In particular, when the voltage of the focus electrode Vf disposed on the top layer of the rear substrate is approximately the same as the ground voltage, various advantages other than the focusing effect can be obtained.

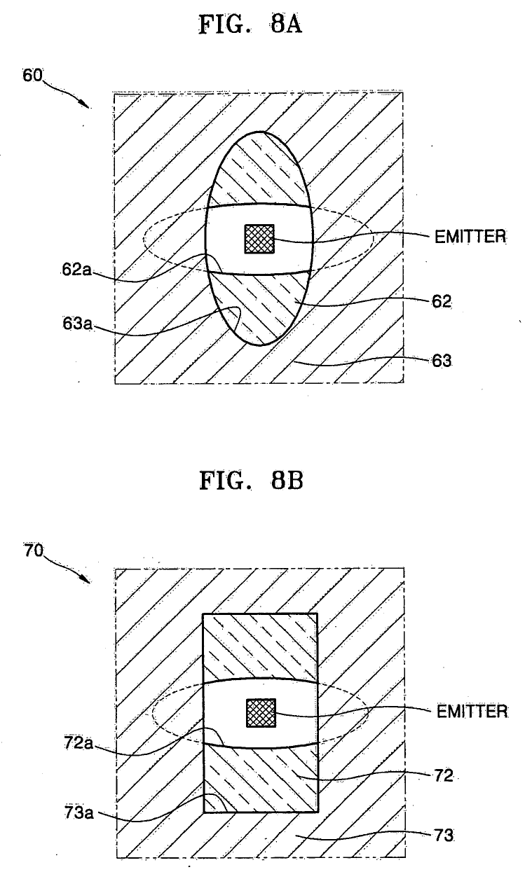

FIGS. 8A and 8B are planar views of the FED according to further embodiments of the present invention. According to this embodiment of the present invention, an FED 60 has an oval-shaped opening portion 62a of a gate electrode 62 which has a horizontal longitudinal axis, and an oval shaped second opening portion 63a of the focus electrode 73 which has a vertical longitudinal axis.

An oval and a rectangle are used in the current embodiments, but the first and second opening portions are not limited to these shapes and can have other shapes. A quadruple lens structure can be formed using a combination of these shapes.

Furthermore, although not shown in the drawings, if a desired distribution of equipotential lines is obtained using the electrostatic quadruple lens structure, the second opening portion can be circular-shaped or square-shaped.

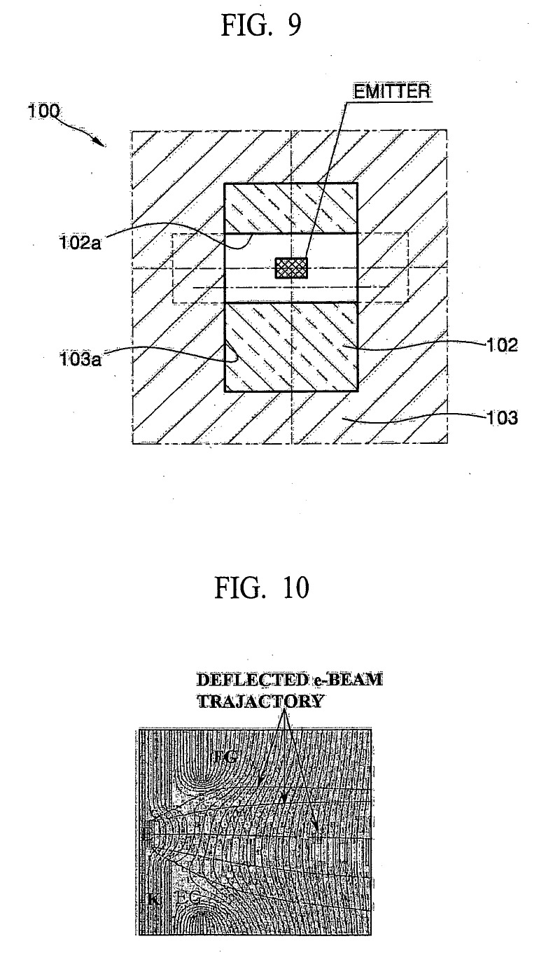

FIG. 9 is a planar view of an FED 100 according to another embodiment of the present invention. The FED 100 according to the current embodiment of the present invention has a gate electrode 102 with a horizontally rectangular first opening portion 102a and a focus electrode 103 with a vertically rectangular opening portion 103a, as in the previous embodiments. However, the second opening portion 103a according to the current embodiment has an eccentric horizontal axis below the horizontal axis of the emitter in the drawing and deflects electron beams.

FIG. 10 is a simulation image of the trajectory of an electron beam of the FED in FIG. 9 according to the current embodiment of the present invention. The second opening portion 103a of the focus electrode 103 (FG) is formed below the center of the emitter and inclined equipotential lines are formed on the path of the electron beams, and thus electrons beams are deflected downward.

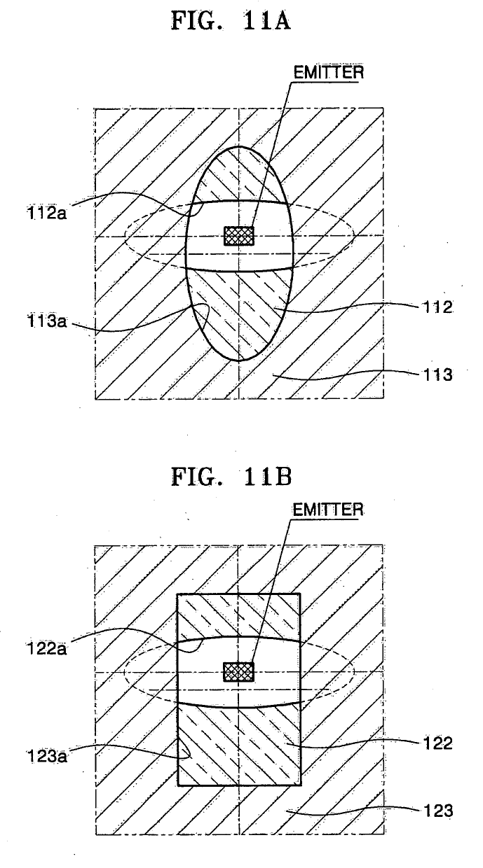

FIGS. 11A and 11B are planar views of an FED according to further embodiments of the present invention. An FED 110 according to an embodiment of the present invention has an oval-shaped first opening portion 112a of a gate electrode 112, which has a horizontally longitudinal axis and an oval-shaped second opening portion 113a of a focus electrode 113 which has a vertically longitudinal axis. The horizontal axis of the second opening portion 113a is below the horizontal axis of the emitter. In addition, an FED 120 according to another embodiment of the present invention has an oval-shaped first opening portion 122a of a gate electrode 122, which has a horizontally longitudinal axis and a vertically rectangular second opening portion 123a of a focus electrode 123. The horizontal axis of the second opening portion 123a is above or below the horizontal axis of the emitter. As described before, the shape of the first and second opening portions is not limited to an oval or a rectangle.

FIG. 12 is a simulation image of an electron beam spots on a surface of an anode of the FED of FIG. 9 according to an embodiment of the present invention. Electron beams incident on the anode are deflected downward from the horizontal axis of the emitter.

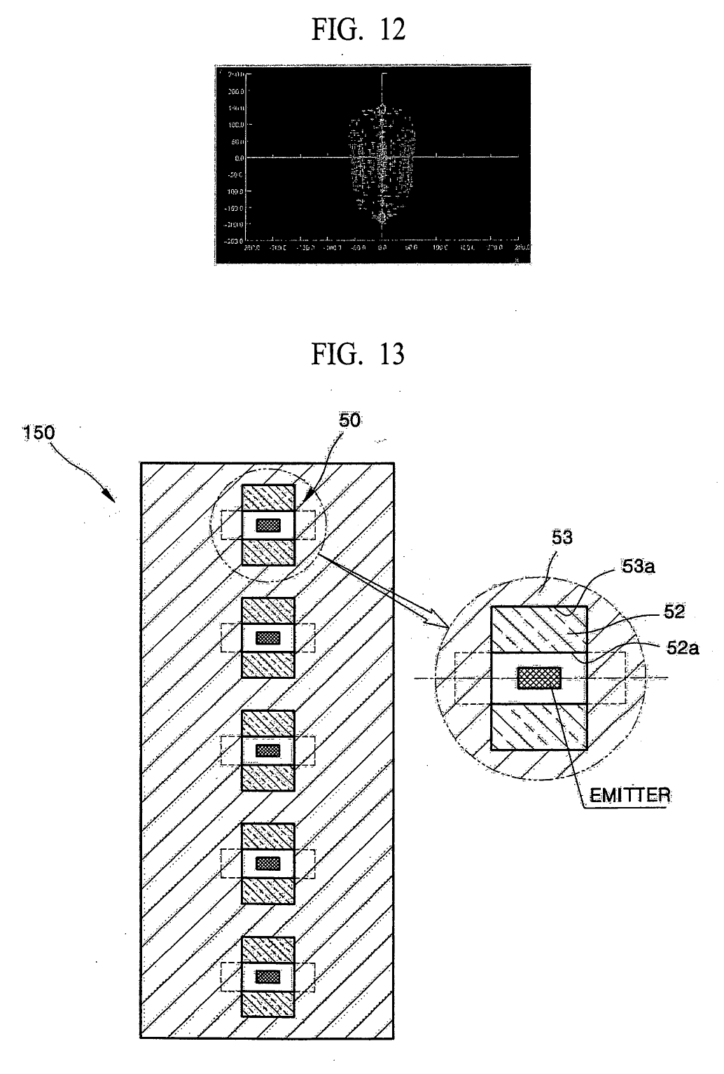

FIG. 13 is a planar view of an FED according to another embodiment of the present invention. According to the current embodiment, an FED 150 has a group of emitters corresponding to a pixel area. Specifically, a plurality of emitters are arranged in a group, and each emitter includes first and second opening portions 52a and 53a. That is, the FED 150 can be an arrangement of a plurality of the FEDs 50 according to the embodiment of the present invention of FIG. 6. Since the fluorescent pattern has a vertically rectangular shape, the emitters can be arranged in a vertical column.

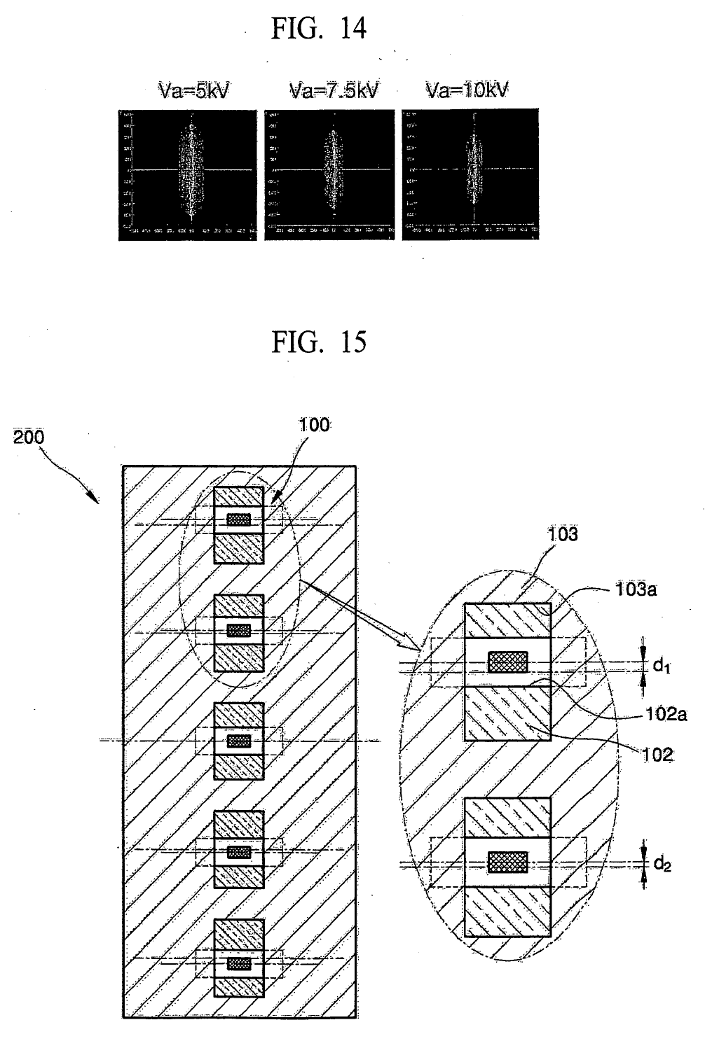

FIG. 14 includes simulation images of electron beam spots on a surface of an anode of the FED of FIG. 9, similar to those of FIG. 7 according to an embodiment of the present invention.

FIG. 15 is a planar view of an FED according to another embodiment of the present invention. AN FED 200 according to the current embodiment includes a group of emitters corresponding to a pixel area. The FED 200 includes emitters respectively having first and second opening portions 52a and 53a, and can be an arrangement of the FEDs 100 of FIG. 9.

However, the degree of deviation of the horizontal axis of the second opening portion 103a from the horizontal axis of the emitter, namely the distance between axes d1 and d2, can vary depending on the construction ratio of the shape of the quadruple lens structure and the distance from the center of the emitters in a group to each emitter in the group. In other words, the farther each emitter is from the center of the emitters in a group, the more the horizontal axis of the corresponding second opening portion 103a is deflected from the horizontal axis of the emitter, and thus electron beams emitted from the emitters can be focused on the center of the group of the emitters.

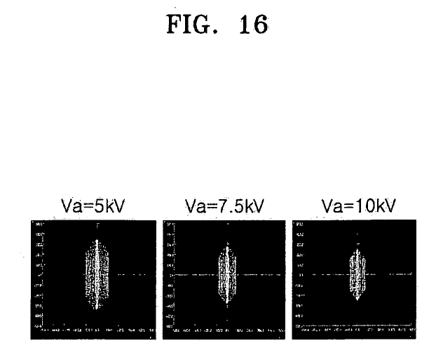

FIG. 16 includes simulation images of an electron beam spots on a surface of an anode of the FED of FIG. 10 according to an embodiment of the present invention. Referring to FIG. 16, the width of electron beams reaching the anode is equal to that of the electron beams of FIG. 15, and the vertical length reduced in the direction of the center and is thus more focused.

In the above-described configuration, the FED according to the present invention includes a quadruple lens structure, focusing electron beams from the emitters and transforming a cross-section of the electron beams into a stripe shape corresponding to a fluorescent pattern. Also, in the FED according to the present invention, a focus electrode has a small potential difference with respect to a gate electrode and thus insulation breakdown is prevented in advance. In addition, the FED according to another embodiment of the present invention has improved brightness and color purity through selectively deflected electron beams emitted from a group of emitters by using an electrostatic quadruple lens structure.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A Field Emission Device (FED), comprising:
a rear substrate including a cathode electrode arranged thereon;
emitters arranged on the cathode electrode and adapted to emit a plurality of electron beams;
a gate electrode arranged above an upper surface of the cathode electrode and adapted to extract electrons from the emitters;
a front substrate facing the rear substrate, the front substrate including an anode electrode and a fluorescent layer arranged on a lower surface thereof; and
a quadruple lens structure arranged between the cathode electrode and the anode electrode and corresponding to each emitter.

2. The FED of claim 1, wherein the quadruple lens structure is adapted to transform a cross-section of the electron beams emitted from the emitters to reduce a horizontal width of the cross-section.

3. The FED of claim 2, wherein a vertical length of the electron beams is equal to a sub-pixel pitch of a fluorescent pattern.

4. The FED of claim 1, further comprising a focus electrode arranged above the upper surface of the gate electrode, wherein the quadruple lens structure includes the gate electrode and the focus electrode.

5. A Field Emission Device (FED), comprising:
a rear substrate including a cathode electrode arranged on an upper surface thereof;
emitters arranged on the cathode electrode and adapted to emit electrons;
a gate electrode arranged above an upper surface of the cathode electrode and including a first insulating layer arranged therebetween and horizontal first opening portions adapted to extract electrons from the emitters;
a focus electrode arranged above an upper surface of the gate electrode and including a second insulating layer arranged therebetween and a vertical second opening portion, at least a part of the second opening portion being in line with the first opening portions;
a front substrate facing an upper surface of the rear substrate and including an anode electrode arranged on a lower surface of the front substrate; and
a vertical fluorescent pattern arranged on a lower surface of the anode electrode.

6. The FED of claim 5, wherein a voltage of the gate electrode is greater than a voltage of the focus electrode.

7. The FED of claim 6, wherein the voltage of the focus electrode is equal to a ground potential.

8. The FED of claim 6, wherein the voltage of the focus electrode is in a range of 0 V to −30 V.

9. The FED of claim 5, wherein the first opening portion has one of a horizontally rectangular shape and a horizontally oval shape, and wherein the second opening portion has one of a vertically rectangular shape and a vertically oval shape.

10. The FED of claim 5, wherein the first opening portion has one of a horizontally rectangular shape and a horizontally oval shape, and wherein the second opening portion has a square or circular shape.

11. The FED of claim 5, wherein a horizontal axis of the second opening portion is eccentric with respect to a horizontal axis of the emitter and is adapted to deflect the electron beam in an eccentric direction.

12. A Field Emission Device (FED), comprising:
a rear substrate including a cathode electrode arranged thereon;
a group of emitters arranged on the cathode electrode and adapted to emit electrons;
a gate electrode arranged above an upper surface of the cathode electrode and adapted to extract electrons from the emitters;
a front substrate facing an upper surface of the rear substrate and including an anode electrode arranged on a lower surface of the front substrate;
a fluorescent pattern arranged on a pixel area of the lower surface of the anode electrode and adapted to emit light by a collision of beams of electrons with the anode electrode; and
a quadruple lens structure arranged between the cathode electrode and the anode electrode and corresponding to each emitter.

13. The FED of claim 12, wherein the group of emitters comprises a plurality of emitters arranged in a vertical column and wherein the quadruple lens structure is adapted to reduce a horizontal width of the emitted electron beams from each emitter.

14. The FED of claim 12, further comprising a focus electrode arranged above an upper surface of the gate electrode, wherein the quadruple lens structure includes the gate electrode and the focus electrode.

15. The FED of claim 12, wherein the quadruple lens structure is adapted to deflect electron beams to a center of the group of emitters.

16. The FED of claim 15, wherein the quadruple lens structure is adapted to deflect electron beams of the emitters disposed relatively far from the center of the group of emitters more than electron beams of the emitters disposed relatively near to the center of the group of emitters.

17. A Field Emission Device (FED), comprising:
a rear substrate including a cathode electrode arranged on an upper surface thereof;
a group of emitters arranged on the cathode electrode and adapted to emit electrons;
a gate electrode arranged above the upper surface of the cathode electrode and including a first insulating layer arranged therebetween and horizontal first opening portions corresponding to each emitter and adapted to extract electrons from the emitter;
a focus electrode arranged above the upper surface of the cathode electrode and including a second insulating layer arranged therebetween and a vertical second opening portion; at least a part of the second opening portion being in line with the first opening portions;
a front substrate facing the upper surface of the rear substrate and including an anode electrode arranged on a lower surface of the substrate; and
a fluorescent pattern adapted to emit light due to collision of electron beams therewith.

18. The FED of claim 17, wherein a voltage of the gate electrode is greater than a voltage of the focus electrode.

19. The FED of claim 18, wherein the voltage of the focus electrode is equal to a ground potential.

20. The FED of claim 18, wherein the voltage of the focus electrode is in a range of 0 V to −30V.

21. The FED of claim 17, wherein the first opening portion has one of a horizontally rectangular shape and a horizontally oval shape, and wherein the second opening portion has one of a vertically rectangular shape and a vertically oval shape.

22. The FED of claim 17, wherein the first opening portion has one of a horizontally rectangular shape and a horizontally oval shape, and wherein the second opening portion has one of a square shape or a circular shape.

23. The FED of claim 17, wherein the group of emitters include a plurality of emitters arranged in a vertical column.

24. The FED of claim 23, wherein the second opening portion corresponding to a part of the group of emitters has a horizontal axis eccentric with respect to a horizontal axis of the group emitters and is adapted to deflect electron beams in an eccentric direction.

25. The FED of claim 23, wherein the second opening portion corresponding to emitters arranged outside the group of emitters has a horizontal axis eccentric with respect to a horizontal axis of the group of emitters and is adapted to deflect electron beams in an eccentric direction.

26. The FED of claim 25, wherein as the distance of the emitters increases from a center of the group of the emitters, a horizontal axis of the second opening portion corresponding to each emitter becomes more eccentric with respect to the horizontal axis of the emitters.
